(19) United States
(12) Patent Application Publication
(10) Pub. No.: US 2002/0164434 A1
(43) Pub. Date: Nov. 7, 2002

(54) ULTRA VIOLET LIGHT CURABLE FLOOR COATING WITH COLORING AGENT

(76) Inventors: MICHAEL TARVIN, ST. PAUL, MN (US); MICHAEL A. RAU, EDEN PRAIRIE, MN (US)

Correspondence Address: HARRY M. LEVY, ESQ, EMRICH & DITHMAR, 300 S. WACKER DRIVE, SUITE 3000, CHICAGO, IL, 60606, US

(21) Appl. No.: 09/395,072

(22) Filed: Sep. 13, 1999

Related U.S. Application Data
(60) Provisional application No. 60/102,220, filed on Sep. 29, 1998.

(51) Int. Cl. C08F 2/48; C08J 3/28

(52) U.S. Cl. 427/500; 427/514; 522/75

(57) ABSTRACT

The present invention provides an indicator for determining when curable coatings have crosslinked or cured thereby permitting the applier to know what part of the floor may be used without affecting the surface and what part of the floor is still in the curing process and may not be disturbed. The invention involves the incorporation in the liquid materials applied to the floor, of a dye or pigment which is visible to the naked eye when the coating is in the liquid state and significantly less visible after the coating has cured. Almost any dye or pigment may be used which is compatible with the various coatings which may be employed in the present invention; provided however, the amount of dye or pigment added is sufficient to be visible when the material is liquid but not so much to prevent the color intensity from being greatly diminished upon curing.

This application is based on patent application serial No. 60/102,220 filed on Sep. 29, 1998.

### FIELD OF THE INVENTION

The present invention relates to a floor coating to be applied in a liquid form curable by the application of suitable radiation, including but not limited to ultra violet (“UV”) light to form a solid floor coating, in situ. The floor coatings of the present invention include coatings with no volatile components to evaporate as solvents as well as water based coatings in which the active ingredients, that is the curable materials, are carried in a water solvent or dispersant to be applied to the floor.

### BACKGROUND OF THE INVENTION

U.S. Pat. No. 4,999,216 for METHOD OF COATING CONCRETE FLOORS WITH PHOTOCURABLE COATINGS discloses a method of coating a concrete floor with a liquid coating composition in liquid form and allowing the liquid to seep into the concrete surface to form a smooth coating, then exposing the coating to light in the ultraviolet and near visible range to cure the coating. Apparatus for carrying the source of ultraviolet light is disclosed in schematic form. As used herein, the terms “floor coating” or “coating” or “curable floor coating” and equivalents are intended to be broadly interpreted and refer to floor coatings applied in the liquid state and capable of curing to a solid state upon being irradiated by suitable radiation, such as ultraviolet light. Such coatings are known, for example, as described in U.S. Pat. No. 4,999,216. Another example of a curable floor coating has, as the two active elements, a urethane acrylate oligomer and an acrylated monomer blend. Curable coatings of this nature are commercially available and known in the art. The present invention does not contemplate limitation to any particular coating other than it be capable of being cured from a liquid to a solid state upon exposure to ultraviolet or other suitable radiation after the coating has been applied to a floor surface. By ultra violet radiation, the present invention intends to include those coatings which are curable or cross link upon exposure to light other than ultra violet or UV light, for instance, near visible light may be used to cure coatings, although perhaps not as quickly as with UV light. Nevertheless, the invention herein described is not limited to coatings which are curable only with UV light but curable upon exposure to radiation in general.

Although there are many systems for coating surfaces with liquid materials which cure upon exposure to suitable radiation, in situ use of these curable materials for coating concrete surfaces such as a factory floor has not been widely promoted. One of the problems involved in the application of curable coatings to concrete floors and the like is that it is difficult for the workers to determine what portion of the floor has setup or cured, that is cross-linked, and what portion has not.

### SUMMARY OF THE INVENTION

The present invention provides an indicator for determining when curable coatings have crosslinked or cured thereby permitting the applier to know what part of the floor may be used without affecting the surface and what part of the floor is still in the curing process and may not be disturbed. The invention involves the incorporation in the liquid materials applied to the floor, of a dye or pigment which is visible to the naked eye when the coating is in the liquid state and significantly less visible after the coating has cured. Almost any dye or pigment may be used which is compatible with the various coatings which may be employed in the present invention; provided however, the amount of dye or pigment added is sufficient to be visible when the material is liquid but not so much to prevent the color intensity from being greatly diminished upon curing.

The invention consists of certain novel features and a combination of parts hereinafter fully described, and particularly pointed out in the appended claims, it being understood that various changes in the details may be made without departing from the spirit, or sacrificing any of the advantages of the present invention.

### DETAILED DESCRIPTION OF A PREFERRED EMBODIMENT

Although there are a variety of cross linkable coatings for which the present invention is appropriate, the invention will hereafter be described with reference to an acrylate-containing coating.

However, the use of an acrylate-containing coating is for purposes of illustration only and is not intended to limit the application of the invention. The invention broadly relates to any coating which is cross linkable or curable upon exposure to suitable radiation and for which there is a need to determine when the coating is still liquid and when the coating has setup or cured.

Specifically, the invention will be described with respect to acrylate-containing coatings, which are 100% active, that is they contain no volatile solvents or water, as well as solvent based coatings, particularly water based coatings. By that, it is intended to mean that coatings for which the cross linkable material is dissolved in a solvent such as water. In general, ultraviolet cured coatings may contain 100% active materials, that is coatings which have no solvent such as water or the like and these coatings typically have very high gloss factors. Because of the high gloss factors, it is nearly impossible visually to discern whether a coated surface is in the liquid state or is in the fully cured state. In general, the only detection method is to touch the coating which not only is impractical but also results in marring the finish. More particularly, the invention involves the use of dyes or pigments which impart a strong color to a clear liquid coating and which color becomes nearly imperceptible at the best, or visually discernible from the liquid state at the least, upon polymerization of the coating system by exposure to suitable radiation, such as ultraviolet light. The ability visually to detect the difference between liquid and solid coating, that is between uncured and cured coatings, is particularly useful when a mobile curing machine is used.

Typically, coatings that undergo polymerization reactions upon exposure to radiation include free radical polymerization, charge transfer and cationic polymerizations and include material such as acrylated urethanes, acrylated epoxies, vinyl ether urethanes, unsaturated polyesters, and cycloaliphatic epoxides. These resins combined with monomers such as acrylate, vinyl ether and vinyl pyrolidones, in combination with a suitable and well known photoinitiators are examples of radiation curable systems such as UV curable systems that benefit from the incorporation of color indicators, as hereinafter described. All of these systems may be 100% active systems that contain no solvent and/or contain volatile solvents and/or may be dispersed in water.

It has been found that any dye or pigment can be used as long as it is compatible with the coating system employed. In general, oil soluble dyes or oil dispersable pigments are required in 100% active organic solvent containing systems, and water soluble dyes or water dispersable pigments are required for water dispersable coatings. If pigments are used, rather than dyes, the optimum pigment should have good transparency and limited opacifying characteristics.

The preferred dye is a blue or cyan dye. A blue dye, used in the appropriate quantity, will impart a strong blue color to the liquid coating and a faint, practically imperceptible blue tone to the cured coating. The differences between the strong blue color of the liquid and practically imperceptible blue tone of the cured coating are clearly distinguishable by the naked eye. The blue tone left in the cured coating helps to neutralize any yellow undertones present in the coating system. It is preferred to have a blue undertone rather than a yellow undertone which naturally occurs in white and pastel colored paints or by the use of resins with a yellow or amber tint. The use of an optical brightener provides fluorescence to a coating by absorbing light in the UV region of the electromagnetic spectrum and re-emitting the light in the blue region of the visible spectrum. The result is a brighter appearance which can effectively mask coating yellowness. The use of a an optical brighter in the proper amount will not add color to the coating but will create a brighter appearance of the coating and is preferred but not necessary in the present invention.

Following are four Examples of coatings incorporating the present invention, two of the coatings being solvent free and two of the coatings being water dispersable coatings. The Examples hereinafter set forth are not meant to be limiting but merely meant to be representative examples of the invention.

### EXAMPLE 1

| Generic Description | Chemical Name | Trade Name | Manufacturer | % |
|---|---|---|---|---|
| Urethane Acrylate Oligomer | Tris (2-hydroxyethyl) | SR-368 | Sartomer Co. | 27.00 |
| | Isocyanurate Triacrylate Esters | | | |
| Acrylate Monomer | Dipentaerythritol Pentaacrylate | SR-399 | Sartomer Co. | 8.00 |
| | Esters | | | |
| Acrylate Monomer | Ethoxylated Trimethylol- | SR-454 | Sartomer Co. | 26.10 |
| | propane Triacrylate Esters | | | |
| Acrylate Monomer | Propoxylated Neopentyl Glycol | SR-9003 | Sartomer Co. | 4.00 |
| | Diacrylate | | | |
| Amine Acrylate Oligomer | Trade Secret | CN-386 | Sartomer Co. | 5.00 |
| Photoinitiator | Hydroxy Ketone Mixture | KIP-100F | Sartomer Co. | 3.00 |
| Photoinitiator | Benzophenone | Benzophenone | Sartomer Co. | 0.20 |
| Cyan/magenta pigment | Trade Secret | Tint Ayd | Daniel Products | 0.05 |
| blend | | UL-20-12 | Co. | |
| Surfactant | Trade Secret | DC-31 | Dow Corning | 0.05 |
| Defoamer | Trade Secret | DC-56 | Dow Corning | 0.005 |
| Optical Brightener | Trade Secret | Keyflour | Keystone | 0.020 |
| | | | Chemicals | |

### EXAMPLE 2

### Urethane Acrylate Base

| Generic Description | Chemical Name | Trade Name | Manufacturer | % |
|---|---|---|---|---|
| Urethane Acrylate Oligomer | Trade Secret | Ebecryl 8807 | UCB Chemicals | 35.00 |
| Acrylate Monomer | Dipentaerythritol Pentaacrylate | DPHPA | UCB Chemicals | 8.00 |
| | Esters | | | |
| Acrylate Monomer | Ethoxylated Trimethylol- | EOTMPTA | UCB Chemicals | 22.00 |
| | propane Triacrylate Esters | | | |
| Acrylate Monomer | Propoxylated Neopentyl Glycol | NPG (PO) DA | UCB Chemicals | 21.00 |
| | Diacrylate | | | |
| Amine Acrylate Oligomer | Trade Secret | Ebecryl P115 | UCB Chemicals | 4.00 |
| Photoinitiator | Hydroxy Ketone Mixture | KIP-100F | Sartomer Co. | 5.00 |
| Photoinitiator | Benzophenone | Benzophenone | Sartomer Co. | 5.00 |
| Cyan/magenta pigment | Trade Secret | Tint Ayd | Daniel Products | 0.05 |
| blend | | UL-20-12 | Co. | |
| Surfactant | Trade Secret | DC-31 | Dow Corning | 0.05 |
| Defoamer | Trade Secret | DC-56 | Dow Corning | 0.005 |
| Optical Brightener | Trade Secret | Keyflour | Keystone | 0.020 |
| | | | Chemicals | |

### EXAMPLE 3

### Epoxy Acrylate Base

| Generic Description | Chemical Name | Trade Name | Manufacturer | % |
|---|---|---|---|---|
| Epoxy Acrylate Oligomer | Trade Secret | Ebecryl 3720 | UCB Chemicals | 29.00 |
| Acrylate Monomer | Dipentaerythritol Pentaacrylate | DPHPA | UCB Chemicals | 8.00 |
| | Esters | | | |
| Acrylate Monomer | Ethoxylated Trimethylol- | EOTMPTA | UCB Chemicals | 23.00 |
| | propane Triacrylate Esters | | | |
| Acrylate Monomer | Propoxylated Neopentyl Glycol | NPG (PO) DA | UCB Chemicals | 26.00 |
| | Diacrylate | | | |
| Amine Acrylate Oligomer | Trade Secret | Ebecryl P115 | UCB Chemicals | 4.00 |
| Photoinitiator | Hydroxy Ketone Mixture | KIP-100F | Sartomer Co. | 5.00 |
| Photoinitiator | Benzophenone | Benzophenone | Sartomer Co. | 5.00 |
| Cyan/magenta pigment | Trade Secret | Tint Ayd | Daniel Products | 0.05 |
| blend | | UL-20-12 | Co. | |
| Surfactant | Trade Secret | DC-31 | Dow Corning | 0.05 |
| Defoamer | Trade Secret | DC-56 | Dow Corning | 0.005 |
| Optical Brightener | Trade Secret | Keyflour | Keystone | 0.020 |
| | | | Chemicals | |

### EXAMPLE 4

| Generic Description | Chemical Name | Trade Name | Manufacturer | % |
|---|---|---|---|---|
| Urethane Acrylate Oligomer | Tris (2-hydroxyethyl) | SR-368 | Sartomer Co. | 27.00 |
| | Isocyanurate Triacrylate Esters | | | |
| Acrylate Monomer | Dipentaerythritol Pentaacrylate | SR-399 | Sartomer Co. | 8.00 |
| | Esters | | | |
| Acrylate Monomer | Ethoxylated Trimethylol- | SR-454 | Sartomer Co. | 26.10 |
| | propane Triacrylate Esters | | | |
| Acrylate Monomer | Propoxylated Neopentyl Glycol | SR-9003 | Sartomer Co. | 4.00 |
| | Diacrylate | | | |
| Amine Acrylate Oligomer | Trade Secret | CN-386 | Sartomer Co. | 5.00 |
| Photoinitiator | Hydroxy Ketone Mixture | KIP-100F | Sartomer Co. | 3.00 |
| Photoinitiator | Benzophenone | Benzophenone | Sartomer Co. | 0.20 |
| Oil Soluble Anthraquinone | Trade Secret | Pylakrome LX- | Pylam Products | 0.04 |
| Dye | | 7709 | | |
| Surfactant | Trade Secret | DC-31 | Dow Corning | 0.05 |
| Defoamer | Trade Secret | DC-56 | Dow Corning | 0.005 |
| Optical Brightener | Trade Secret | Keyflour | Keystone | 0.020 |
| | | | Chemicals | |

### EXAMPLE 5

| Generic Description | Chemical Name | Trade Name | Manufacturer | % |
|---|---|---|---|---|
| Acrylate Emulsion | Trade Secret | Laromer 8895 | BASF Corp. | 70.00 |
| Oxidized Polyethylene | Trade Secret | Esi-Cryl 325 N | CCP, Inc. | 5.00 |
| Emulsion | | | | |
| Photoinitiator | Trade Secret | Darocur 1173 | Ciba Geigy | 1.00 |
| Cyan/Magenta Pigments | Trade Secret | Tint Ayd | Daniel Products | .20 |
| | | WD-2018 | Co. | |
| Silicone Surfactant | Trade Secret | Byk 346 | Byk-Chemie | .30 |
| Defoamer | Trade Secret | SE-21 | Wacker | 0.02 |
| | | | Silicones | |
| Water | | | | 23.48 |

### EXAMPLE 6

| Generic | Chemical | | | |
|---|---|---|---|---|
| Description | Name | Trade Name | Manufacturer | % |
| Acrylate | Trade | Laromer 8895 | BASF Corp. | 70.00 |
| Emulsion | Secret | | | |
| Oxidized | Trade | Esi-Cryl 325 N | CCP, Inc. | 5.00 |
| Polyethylene | Secret | | | |
| Emulsion | | | | |
| Photoinitiator | Trade | Darocur 1173 | Ciba Geigy | 1.00 |
| | Secret | | | |
| Water Soluble | Acid | 16569 Brilliant | ChemCentral | 0.30 |
| Anthraquinone | Blue 80 | Blue | Corp. | |
| Dye | | | | |
| Silicone | Trade | Byk 346 | Byk-Chemie | .30 |
| Surfactant | Secret | | | |
| Defoamer | Trade | SE-21 | Wacker | 0.02 |
| | Secret | | Silicones | |
| Water | | | | 23.48 |

### EXAMPLE 7

| Generic Description | Chemical Name | Trade Name | Manufacturer | % |
|---|---|---|---|---|
| Urethane-Acrylate Emulsion | Trade Secret | Neorad 440 | Zeneca Resins | 70.00 |
| Oxidized Polyethylene | Trade Secret | Esi-Cryl 325 N | CCP, Inc. | 5.00 |
| Emulsion | | | | |
| Photoinitiator | Trade Secret | Darocur 1173 | Ciba Geigy | 1.00 |
| Cyan/Magenta Pigments | Trade Secret | Tint Ayd | Daniel Products | .20 |
| | | WD-2018 | Co. | |
| Silicone Surfactant | Trade Secret | Byk 346 | Byk-Chemie | .30 |
| Defoamer | Trade Secret | SE-21 | Wacker | 0.02 |
| | | | Silicones | |
| Water | | | | 23.48 |

### EXAMPLE 1

Referring to Example 1, the Urethane Acrylate Oligomer purchased from the Sartomer Co. under the trade designation SR-368 is a white, crystalline, solid triazin compound with a melt point of 52-54° C. which may be used in free radical polymerization. SR-368 typically has a functionality of 3, an inhibitor in ppm of 100 MEHQ a solvent present at 0.1 wt. %, water present at 0.2 wt. % and acid present at 0.1 wt. %. The color, APHA (G=Gardner scale) 1G, the specific gravity 5° C. 1.300, the refractive index is 1.4489, and the molecular weight is about 423. The urethane acrylate oligomer defines the primary physical properties of the coating such as abrasion resistance, hardness, flexibility and exterior durability. Alternatives to this material are well known to those of ordinary skill in the art.

The Acrylate Monomer of Example 1 purchased from the Sartomer Co. under the trade designation SR-399 provides abrasion resistance, flexibility with hardness and fast cure response for ultraviolet and electron beam curing. It is a low skin irritant monomer and has a functionality of 5 and is a clear liquid. The inhibitor in ppm is 270 MEHQ, solvent is present at 0.1 wt. %, water is present at 0.1 wt. % and acid is present at 0.1 wt. %. The color APHA (G=Gardner scale) is 50, the specific gravity at 25° C. is 1. 192, the viscosity, cps is 13,600 @25° C., the refractive index is 1.4885, the surface tension in dynes/cm is 39.9 and the Tg, ° C. is 90. The molecular weight is 525. In the preferred embodiment of Example 1, the SR-399 or acrylate monomer is a pentafunctional acrylate monomer which increases the cross link density of the coating and ultimate hardness. Alternatives to this material are well known to those of ordinary skill in the art.

The Acrylate Monomer sold under the trade designation SR-454 obtained from the Sartomer Co. is an ethoxylated trimethylolpropane triacrylate ester which is a fast curing monomer for use in free radical polymerization. The SR-454 acrylate monomer provides viscosity reduction or control and also help the cross linking density of the floor covering coating. The acrylate monomer SR-454 has a functionality of 3 and is a clear liquid. The inhibitor in ppm is 255 MEHQ, solvent is present at 0.1 wt. %, water is present at 0.15 wt. % and acid is present at 0.02 wt. %. The color APHA (G=Gardner scale) is 55, the specific gravity at 25° C. is 1.103, the viscosity in cps is 60 @25° C. The refractive index is 1.4689, the surface tension in dynes/cm is 39.6 and the molecular weight is 428. In the preferred embodiment of Example 1, the SR-454 or acrylate monomer is a tri-functional acrylate monomer which increases the cross link density and reduces viscosity. Alternatives to this material are well known to those of ordinary skill in this art.

The Acrylate Monomer sold under the trade designation SR-9003 obtained from the Sartomer Co. is a propoxylated neopentyl glycol diacrylate which is a low viscosity, monomer for use in free radical polymerization. This Di-functional acrylate provides maximum viscosity reduction to the coating. The acrylate monomer SR-9003 has a functionality of 2 and is a clear liquid. The inhibitor in ppm is 350 HQ, solvent is present at 0.1 wt. %, water is present at 0.3 wt. % and acid is present at 0.05 wt. %. The color APHA (G=Gardner scale) is 35, the specific gravity at 25° C. is 1.005, the viscosity in cps is 15 @25° C. the refractive index is 1.4464, the surface tension in dynes/cm is 32.0 and the molecular weight is 328. Alternatives to this material are well known to those of ordinary skill in the art.

The Amine Acrylate Monomer sold under the trade designation CN-386 obtained from the Sartomer Co. is used to assist the polymerization reaction which occurs in the presence of atomspheric oxygen. The amine acrylate oligomer is a Di-functional amine synergist used in conjunction with a photosensitizer such as benzophenone, and promotes rapid curing under suitable radiation such as UV light. The amine synergist reduces odors in both the liquid and cured film, and reduces blooming or migration and reduces color fading of certain pigments. The amine acrylate oligomer is a clear liquid having a color APHA (G=Gardner scale)<3G, the specific gravity @25° C. is 1.0 @20° C., the viscosity in cps is 25 @25° C., and has a flash point <100° C. Alternatives to this material are well known to those of ordinary skill in this art.

A Photoinitiator sold under the trade designation Esacure KIP-100F obtained from the Sartomer Co. is a hydroxy ketone mixture which is 70% by weight of the oligomer (2-hydroxy-2-methyl-1-(4-)1-methylvinyl)phenyl)propanone] having a molecular weight of 204.7 per unit of the oligomer and 30% by weight 2-hydroxy, 2-methyl, 1-phenyl, 1-propanone having a molecular weight of 164.2. The Esacure KIP-100F is a liquid mixture and is highly reactive, non-yellowing initiator for the photopolymerization of radiation curable systems based on acrylic unsaturated oligomers and monomers. It is a clear, slightly yellow viscous liquid which has a faint characteristic odor. It is insoluble in water, but soluble in most common organic solvents, monomers, prepolymers and is compatible with resins. It has a boiling point greater than about 200° C. and a flash point of 100° C. (closed cup-pensky martens). The material has a density of 1.1 g/cm³ 20° C. and a viscosity of 15-30 Pa.s. (Brookfield 20 rpm 20° C.). Alternatives to this material are well known to those of ordinary skill in this art.

The Photoinitiator benzophenone purchased from the Sartomer Co. is a white crystalline solid and is well known in the UV curing art. It has a melt range of 48-49° C. and is insoluble in water but soluble in chloroform, ethyl alcohol and ether. It has a molecular weight of 0.1%.

The Cyan/Magenta pigment blend obtained from the Daniel Products Co. under the trade designation Tint-Ayd UL-20-12 is a blend of finely dispersed lightfast cyan and magenta pigments which, together exactly complement yellow to produce neutral grays. Small amounts of this material masks the initial yellowness of whites after-yellowing due to aging or overbake. Slightly higher amounts of this material produce a warm, blue-white tone. 1/10 of 1% of this material or less increases the hiding of untoned whites by 10-15% or maintains the hiding level of untoned white with 10-15% less TiO₂ at considerable cost savings. The pigments are distributed in a universal vehicle present in an amount of 0.05- 0.1% by weight. Alternatives to this material are well known to those of ordinary skill in this art.

The Surfactant DC-31 obtained from the Dow Corning Co. under the trade designation DC-31, is a methacryloxy functional silicone polyether copolymer and is a clear liquid which has a low coefficient of friction; consistent performance over time; is readily dispersible in varnish and ink formulation, has compatibility with polyester and epoxy-based acrylate radiation-cured formulations; low silicone volatility and is capable of reaction under suitable radiation such as UV light. It has a viscosity in cps of 300 and a flash point, zeta flash, 0° C. of greater than 61. The surfactant enhances the leveling and increases the mar resistance of the coating by reducing the coefficient of friction. Alternatives to this material are well known to those of ordinary skill in this art.

The Defoamer used in Example 1 is obtained from the Dow Corning Co. under the trade designation DC-56 and is an air release silicone fluid and air release additive useful in solvent, solventless and powder systems. It is a silicone fluid which is a leveling agent, promotes deareation, increases mar resistance. The Dow Corning material should be used in diluted concentrations between 0.1 to 1.0 wt. % based upon the total solids in the system. It is a light straw color; 100% solids. It has a specific gravity at 25° C. of 1.006; a flash point, closed cup, ° C. of greater than 101; a viscosity at 25° C., cs of 1500. Suitable diluents are various aromatics such as xylene, toluene and mineral spirits. It is also soluble in chlorinated hydrocarbons. Alternatives to the defoamer are well known to those of ordinary skill in this art.

The Optical Brightener obtained from Keystone Chemicals under the trade designation Keyflour is a 2H-1-Benzopyran-2-One, 7-(diethylamino)-4-methyl. It is in the aminocoumarin family and is a powder. Use of the optical brightener was discussed above.

### EXAMPLE 2

Example 1 and Example 2 are the same except for the Oil Soluble Anthraquinone Dye obtained from Pylam Products Co. under the trade designation Pylakrome LX-7709. This dye is a Pylam oil bright blue color, which is not compatible with oxidizing and reducing agents which may destroy color. Decomposition products are CO, CO₂ oxides of nitrogen, sulfur and other potentially toxic fumes. Alternatives to this material are well known to those of ordinary skill in this art.

### EXAMPLE 3

The Acrylate Emulsion obtained from BASF Corp. under the trade designation Laromer 8895 is a waterborne emulsion based on a polyester acrylate. The nonvolatile fraction is 50±2% by weight (ISO 3251, DIN V 53 216 Part 1; 1 h at 125° C. The viscosity at 23° C. mPa• is 150-500. The mass density at 20° C. in g/cm³ is ca. 1.0 and the ph value at 23° C. is 5±1. Laromer LR 8895 is compatible with a variety of thickeners such as Collacral®P and PU; Latekoll®D and Acrysol®RM 8 (registered trademark of Rohm and Haas). Laromer LR 8895 has limited compatibility with esters, ketones and glycol ethers; and with acrylic monomers (such as trimethylolpropane triacrylate and tripopylene glycol diacrylate). Laromer LR 8895 coatings feature hardness and mar resistance to chemicals. It is applied with conventional equipment and its viscosity is adjusted by the addition of water. The photoinitiator must be added to Laromer LR 8895 if it is to be cured by ultraviolet radiation. The proportion of initiator to be added is 1.0 to 3.0%, expressed in terms of the Laromer LR 8895 in delivery form. The water must be completely expelled from the coatings before they are cured by ultraviolet radiation or electron beams, otherwise they will be dull and of poor mechanical strength.

The Oxidized Polyethylene Emulsion obtained from CCP, Inc. under the trade designation Esi-Cryl 325 N is a wax emulsion which is very hard, highly scuff resistant; provides high gloss and black heel mark resistance. It is a nonionic polyethylene wax emulsion typically having 35% solids, a pH of about 10 and a weight of about 8.3 pounds per gallon. It is a light tan emulsion and a nonionic surfactant. It has a ASTM D-5 hardness of less than 0.5 and an acid number of based wax of 25.

The Photoinitiator used in Example 3 is obtained from Ciba Geigy Corporation under the trade designation Darocur 1173 is a good liquid photoinitiator for use in a wide variety of UV curing formulations. It has good solvency properties and can act as a solvent for other photoinitiators. It also acts as a diluent for viscosity reduction. The Darocur 1173 is 2-hydroxy-2-methyl-1-phenyl-propan-1-one (HMPP) C₁₀H₁₂O₂ is intended for the production of radiation-curable coating for wood, wood based materials, paper and printing inks. The photoinitiator has a clear, colorless to light yellow liquid appearance, a molecular weight, g/mole of 164.2, a boiling point, C of 80.81°C. @1 mm Hg. 250° C., a density, g/ml of 1.074 1.078. The UV absorption peaks, nm at 265, 280, 320, 335. It is also a good liquid photoinitiator used in a wide range of UV curing formulations with good solvency properties that can act as a solvent for other photoinitiators. It also acts as a diluent for viscosity reduction. The absorbance spectra is of high concentration 4×10⁽⁻⁴⁾ g/ml in methanol and low concentration 2×10⁽⁻⁵⁾ g/ml in methanol.

The Cyan/Magenta Pigments obtained from the Daniel Products Co. under the trade designation Tint Ayd WD-2018 is a blend of finely dispersed, lightfast cyan and magenta pigments which, together exactly complement yellow to produce neutral grays. The WD 2018 is a water/surfactant/glycol at 0.04-0.1% by weight. The WD-2018 has a specific gravity of 1.05 and a flash point of 128° F. The Silicone Surfactant used in Example 3 is obtained from the Byk-Chemie Company under the trade designation Byk 346. This is a polyether modified dimethylpolysiloxane which is a paint additive. The proper chemical name for the compound is 2-methoxymethylethoxypropanol. The material has a boiling range of 360° F. (184° C.), a vapor density in air greater than 1. It is a brownish liquid with a ether-like odor. The specific gravity is 1.2. It has a flash point of 178° F. (81° C.) and an auto ignition temperature of 518° F.(270° C). The hazardous combustion products are carbon monoxide and carbon dioxide, silicon compounds and formaldehyde.

The Defoamer used in Example 3 and obtained from Wacker Silicones under the trade designation SE-21 is an aqueous emulsion of silicone fluid. It is a polydimethylsiloxane and is an antifoam emulsion. Alternatives to all of the materials set forth in Examples 1-3 are well known to those of ordinary skill in the art.

Example 4 is similar to Example 3 with the exception of the dye. In Example 3, a cyan/magenta pigment was used whereas in Example 4 a water soluble anthraquinone dye of the same general type used in Example 2 was used.

The Acid Blue 80 dye obtained from the ChemCentral Corp. under the trade designation 61569 Brilliant Blue is an anthraquinone dye of the type previously discussed.

While there has been disclosed what is considered to be the preferred embodiment of the present invention, it is understood that various changes in the details may be made without departing from the spirit, or sacrificing any of the advantages of the present invention.

1. A liquid organic curable floor coating material having at least one carbon-carbon double bond which undergoes free radical polymerization upon exposure to suitable radiation,
said coating material containing a dye or pigment in sufficient quantity visibly to color the liquid which color is noticeably less visible when the liquid organic material undergoes polymerization upon exposure to suitable radiation,
whereby there is provided a visible indicator to differentiate to the naked eye when the coating is liquid and when the coating has polymerized to a solid.

2. The liquid organic curable floor coating of claim 1, wherein the organic material contains one or more of an acrylated urethane, acrylated epoxy, vinyl ether urethane, unsaturated polyesters and cycloaliphatic epoxides.

3. The liquid organic curable floor coating of claim 2, wherein the liquid floor coating contains not less than about 90% by weight of material which undergoes polymerization upon exposure to suitable radiation.

4. The liquid organic curable floor coating of claim 3,
wherein the coating material contains a photoinitiator and an optical brightener and a surfactant.

5. A liquid acrylate-containing UV curable floor coating capable of curing from a liquid to a solid upon being subjected to UV light,
said coating containing a dye or pigment in sufficient quantity visible to color the liquid which color is noticeably less visible when the liquid acrylate-containing coating is cured with UV lights.
whereby there is provided a visible indicator to differentiate to the naked eye when the coating is liquid and when the liquid coating has cured to a solid.

6. The liquid acrylate-containing UV curable floor coating of claim 5, wherein the liquid coating contains not less than about 90% by weight of an acrylate-containing material.

7. The liquid acrylate-containing UV curable floor coating of claim 5, wherein the coating contains a urethane acrylate oligomer.

8. The liquid acrylate-containing UV curable floor coating of claim 5, wherein the coating contains an acrylate monomer.

9. The liquid acrylate-containing UV curable floor coating of claim 5, wherein the coating contains an amine acrylate oligomer.

10. The liquid acrylate-containing UV curable floor coating of claim 5, wherein the dye or pigment is an anthraquinone dye.

11. The liquid acrylate-containing UV curable floor coating of claim 5, wherein the dye or pigment is present in an amount not less than about 0.001% by weight of the liquid coating.

12. The liquid acrylate-containing UV curable floor coating of claim 5, wherein the dye or pigment is present in an amount not greater than about 0.2% by weight of the liquid coating.

13. The liquid acrylate-containing UV curable floor coating of claim 5, wherein the coating contains a photoinitiator.

14. The liquid acrylate-containing UV curable floor coating of claim 5, wherein the coating contains an optical brightener.

15. The liquid acrylate-containing UV curable floor coating of claim 5, wherein the coating contains a photoinitiator and an optical brightener and a surfactant and a defoamer.

16. A liquid acrylate-containing UV curable floor coating capable of curing from a liquid to a solid upon being subject to UV light,
said liquid containing not less than about 90% by weight or an acrylate-containing material,
said coating containing a dye in an amount not less than about 0.001% by weight of the liquid visibly to color the liquid which color is noticeably less visible when the liquid acrylate-containing coating is cured with UV light,
whereby there is provided a visible indicator to differentiate to the naked eye when the coating is liquid and when the liquid coating has cured to a solid.

17. A liquid acrylate-containing UV curable floor coating capable of curing from a liquid to a solid upon being subjected to UV light,
said liquid containing not less than about 90% by weight of an acrylate-containing material,
said coating containing a pigment in an amount not less than about 0.05% by weight of the liquid visibly to color the liquid which color is noticeably less visible when the liquid acrylate-containing coating is cured with UV light,
whereby there is provided a visible indicator to differentiate to the naked eye when the coating is liquid and when the liquid coating has cured to a solid.

18. The liquid acrylate-containing UV curable floor coating of claim 17, where the acrylate-containing material includes an acrylate oligomer, an acrylate monomer, and an amine acrylate oligomer.

19. A water-based acrylate-containing UV curable floor coating capable of curing from a liquid to a solid upon being subjected to UV light
said coating containing a dye-or pigment in sufficient quantity visibly to color the liquid which color is noticeably less visible when the water-based acrylate-containing coating is cured with UV light,
whereby there is provided a visible indicator to differentiate to the naked eye when the coating is applied as a liquid and when the liquid coating has cured to a solid.

20. A water-based acrylate-containing UV curable floor coating capable of curing from a liquid to a solid upon being subjected to UV light, said water-based acrylate-containing coating having acrylate-containing material present in the water-based liquid coating in the range of from about 25% to about 45% by weight of the liquid,
said coating containing a dye present in an amount not less than about 0.001% by weight of the liquid or pigment present in an amount not less than about 0.05% by weight of the liquid visibly to color the liquid which color is noticeably less visible when the liquid acrylate-containing coating is cured with UV light,
whereby there is provided a visible indicator to differentiate to the naked eye when the coating is liquid and when the liquid coating has cured to a solid.
